(19) United States
(12) Patent Application Publication
(10) Pub. No.: US 2002/0141011 A1
(43) Pub. Date: Oct. 3, 2002

(54) Optical free space signalling system

(76) Inventors: Alan E. Green, Ickleton (GB); Euan Morrison, Ickleton (GB); Robert M. Pettigrew, Ickleton (GB); Andrew M. Parkes, Ickleton (GB); Gordon M. Edge, Ickleton (GB)

Correspondence Address: NIXON & VANDERHYE P.C., 8th Floor, 1100 North Glebe Road, Arlington, VA, 22201, US

(21) Appl. No.: 09/950,004

(22) Filed: Sep. 12, 2001

Related U.S. Application Data
(63) Continuation-in-part of application No. 09/367,223, filed on Aug. 11, 1999.
(63) Continuation-in-part of application No. 09/892,511, filed on Jun. 28, 2001.

(30) Foreign Application Priority Data
Feb. 11, 1997 (GB) 9702726.2
Mar. 24, 1997 (GB) 9706062.8
Feb. 11, 1999 (GB) 9903142.9
Sep. 13, 2000 (GB) 0022466.7
Sep. 20, 2000 (GB) 0023104.3
Oct. 20, 2000 (GB) 0025806.1
Feb. 11, 1998 (WO) PCT/GB98/00421
Aug. 13, 1999 (GB) 9916422.0
Feb. 11, 2000 (WO) PCT/GB00/00456

(51) Int. Cl. H04B 10/20; H04J 14/00; H04B 10/00

(52) U.S. Cl. 359/118; 359/159

(57) ABSTRACT

There is described a computer network in which a free space light beam is modulated to convey data to and from a network device. The light beam is generated by a signalling device which includes an optical system which collects the light beam and directs the light beam in an exit direction, and also includes a detector which detects the presence of a network device and a beam alignment system which varies the exit direction to align the light beam with the network device. The computer network has particular application in business premises such as an office. The computer network also has applications in public transport stations, for example an airport, and a public transport vehicle, for example an aeroplane.

This invention relates to a signalling system. An aspect of the invention relates to a computer network within a business premises such as an office. Another aspect of the invention relates to a computer network within a public transport vehicle such as an aeroplane, a train or a bus.

The majority of computer networks rely upon cables to connect network devices to the rest of the network. However, using cables has a number of disadvantages. For example, if it is desired to move a laptop computer which is running a network application to a new location, it is usually necessary to close down the application and turn the laptop computer off, unplug the cable from the network socket, move the laptop computer to the new location, plug the cable in a network socket at the new location, turn the laptop computer back on and reopen the application. This is a time consuming process and the continuous connection and disconnection of cables inevitably results in wear and tear of the connectors. Another disadvantage of using cables is that, unless the cables are carefully positioned, someone can catch the cable causing damage to themselves and/or the network device. A proliferation of cables can also be an eyesore.

It has been proposed to remove the requirement for cables by utilising radio waves to convey data between network devices and the rest of the network. A disadvantage of using radio waves is that the maximum data transfer rate is unacceptably low for many applications.

According to an aspect of the invention, there is provided a computer network having first and second signalling devices. One of the first and second signalling devices emits a light beam which is directed to the other of the first and second signalling devices. The first signalling device includes a modulator which modulates the emitted light beam in accordance with network data and the second signalling device includes a detector which detects the modulated light beam and generates a corresponding electrical signal which is processed to recover the network data.

By using a directed light beam, high data transfer rates are achievable. Preferably, a tracking system is employed so that the light beam from the first signalling device remains directed at the second signalling device in the event of relative movement between the first and second signalling devices.

In embodiments of the invention, a computer network according to the invention is installed in a business premises, such as an office or a factory. In other embodiments of the invention, a computer network according to the invention is installed within a public transport building, such as an airport terminal or a railway or bus station. In further embodiments of the invention, a computer network according to the invention is installed in a public transport vehicle, such as an aeroplane or a train.

Exemplary embodiments of the present invention will now be described with reference to the accompanying drawings in which:

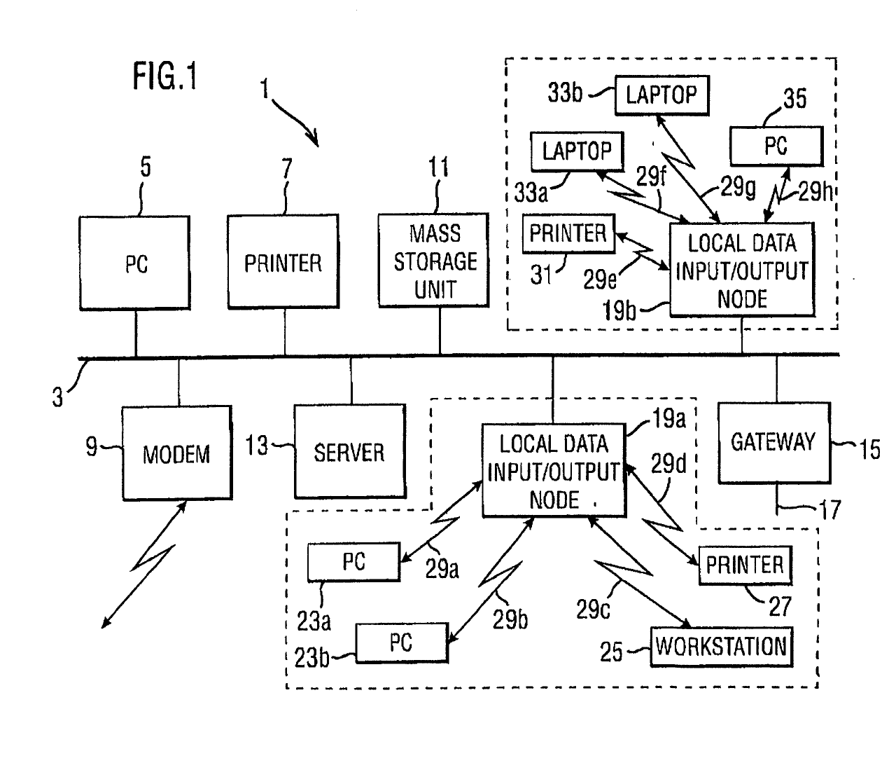

FIG. 1 is a schematic diagram of a computer network within an office environment;

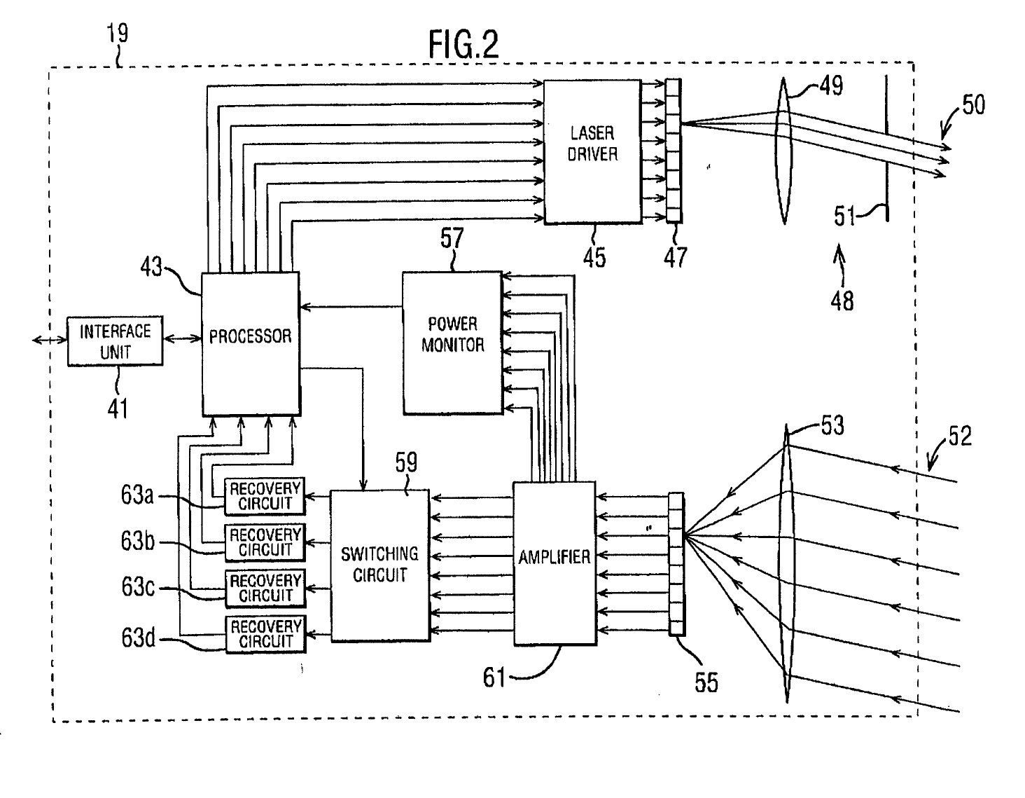

FIG. 2 is a schematic diagram of a fixed node which forms part of the computer network illustrated in FIG. 1;

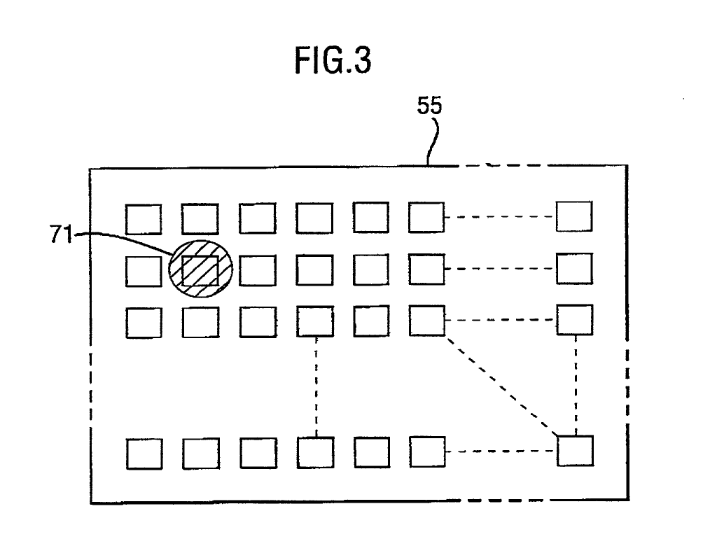

FIG. 3 is a schematic diagram of a pixelated detector array which forms part of the fixed node shown in FIG. 2;

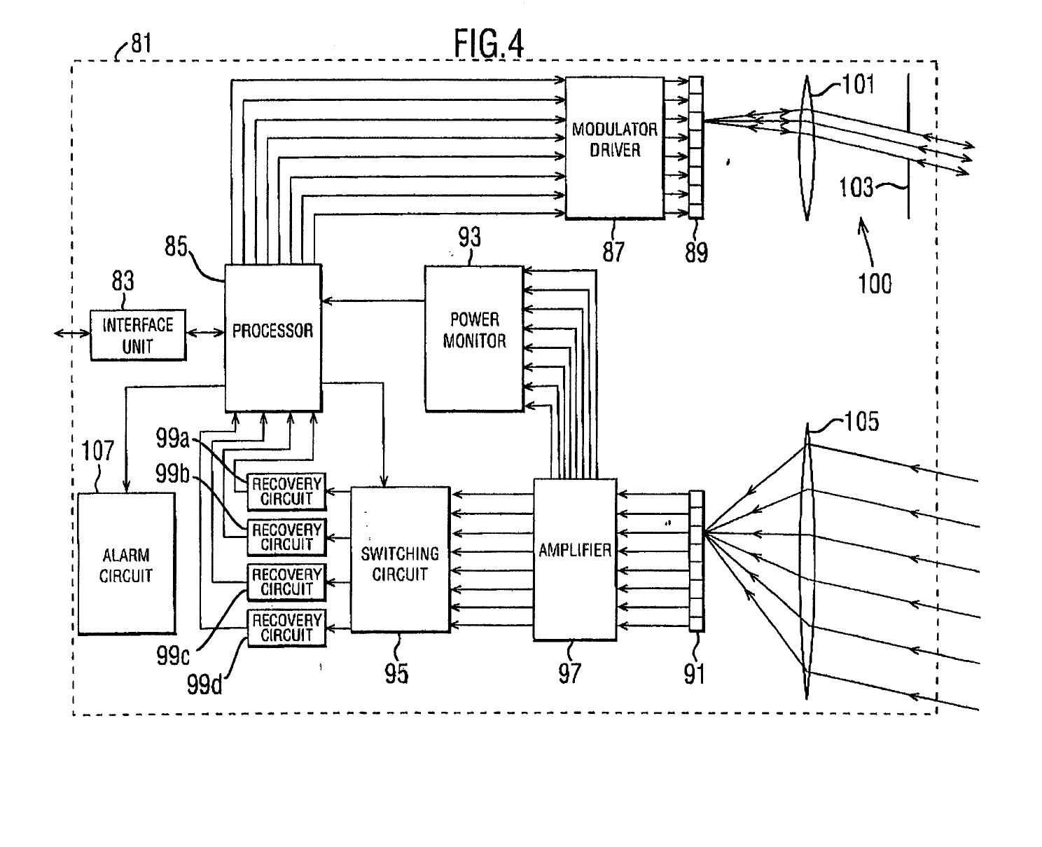

FIG. 4 is a schematic diagram of a device node which forms part of a network device of the computer network shown in FIG. 1;

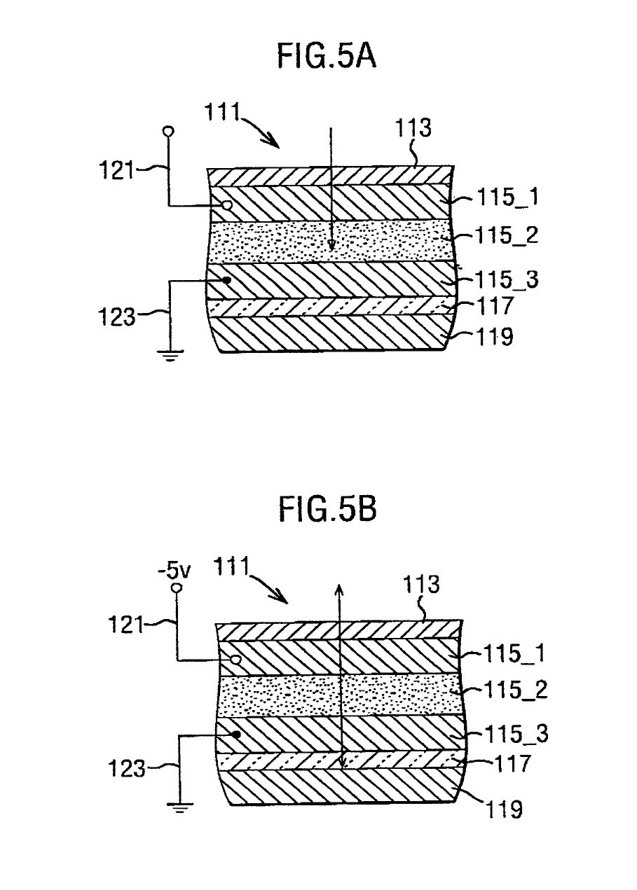

FIG. 5A is cross-sectional view of one modulator of a modulator array which forms part of the device node illustrated in FIG. 4 in a first operational mode in which no DC bias voltage is applied to the electrodes thereof;

FIG. 5B is a cross-sectional view of one modulator of the modulator array which forms part of the device node illustrated in FIG. 4 in a second operational mode in which a bias voltage is applied to the electrodes thereof;

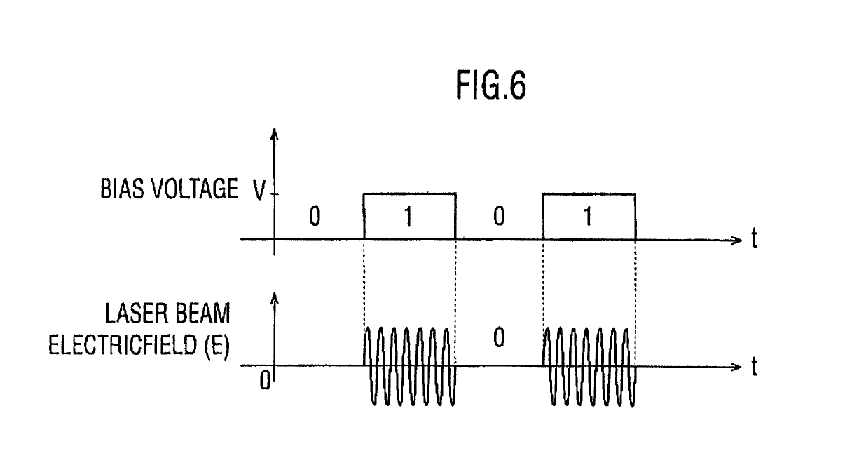

FIG. 6 is a signal diagram which schematically illustrates the way in which the light incident on the modulator shown in FIGS. 5A and 5B is modulated in dependence upon the bias voltage applied to the pixel electrode;

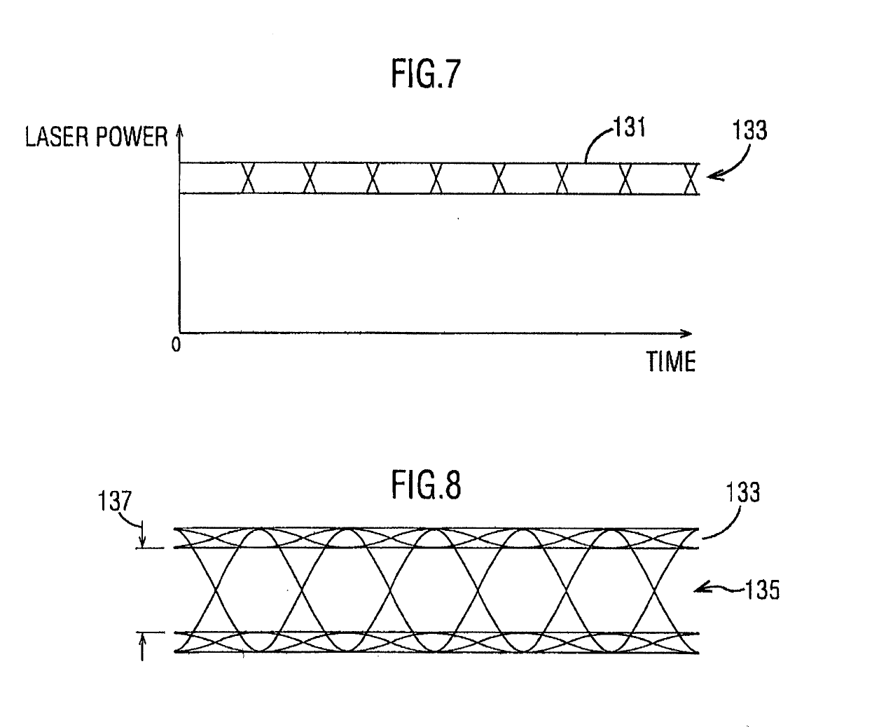

FIG. 7 is a plot illustrating the way that the power of a laser beam emitted by a fixed node is varied to achieve a small signal modulation for downlink data transmitted from the fixed node to a device node;

FIG. 8 is an eye diagram schematically illustrating the effect of the small signal modulation on the uplink data transmitted from the device node to the fixed node;

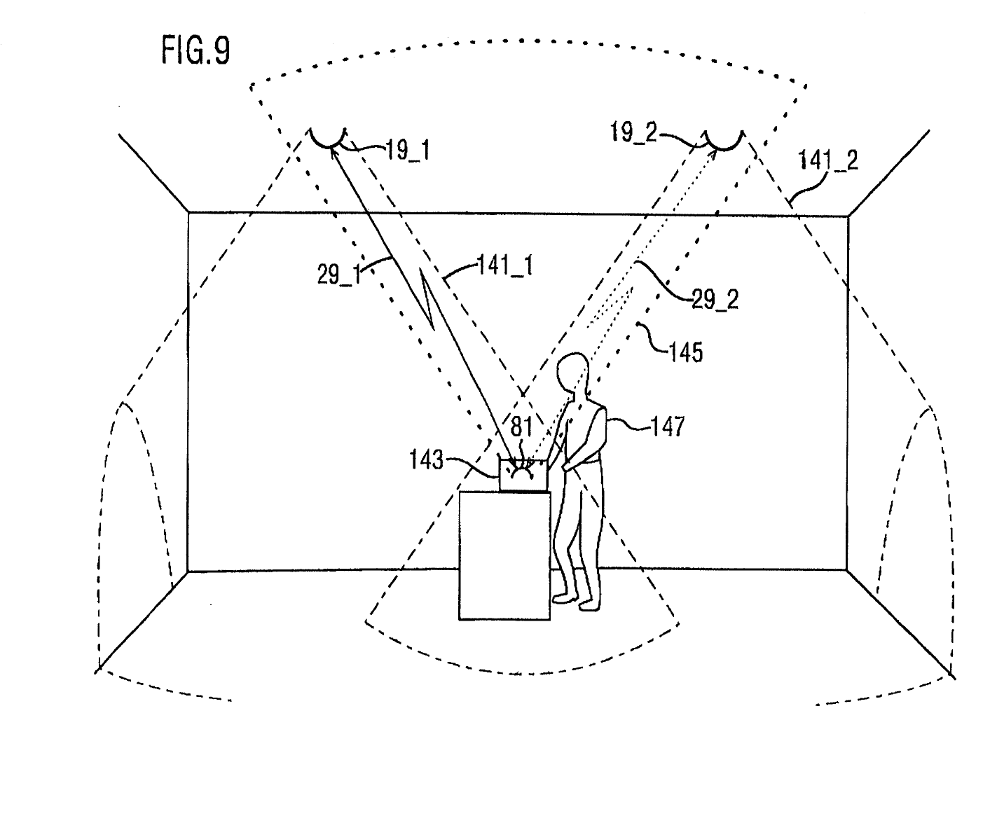

FIG. 9 is a schematic diagram illustrating a network device of the computer network shown in FIG. 1 optically linked to more than one fixed node;

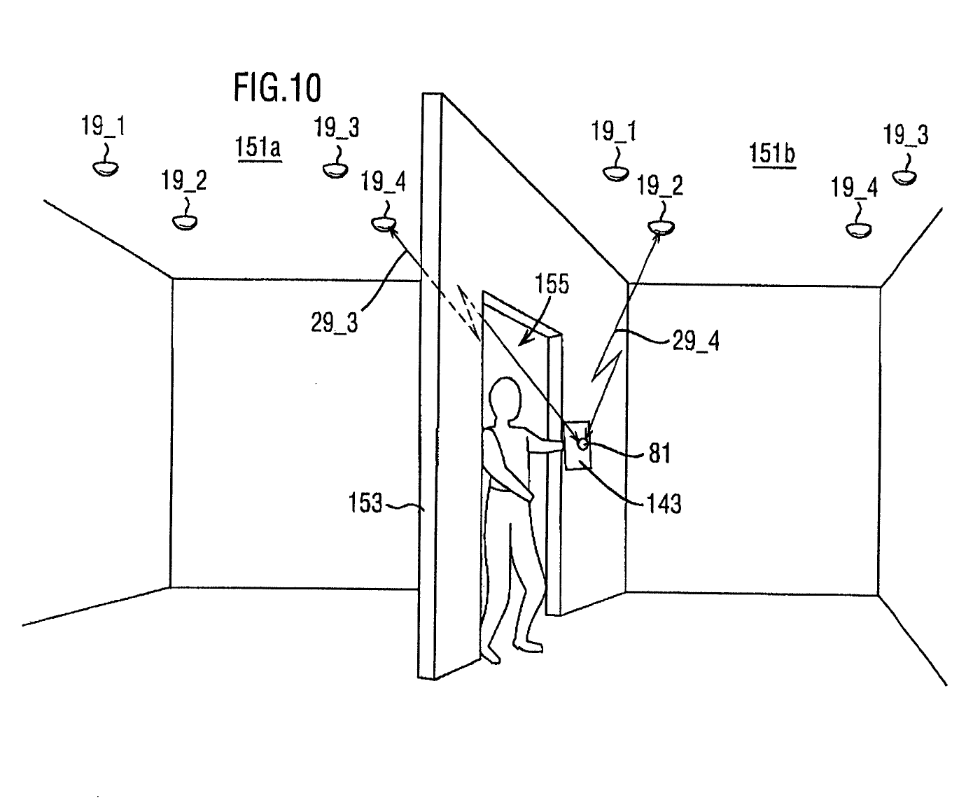

FIG. 10 is schematic diagram illustrating how an optical link between a network device and the rest of the computer network is maintained as the device is moved between neighbouring rooms;

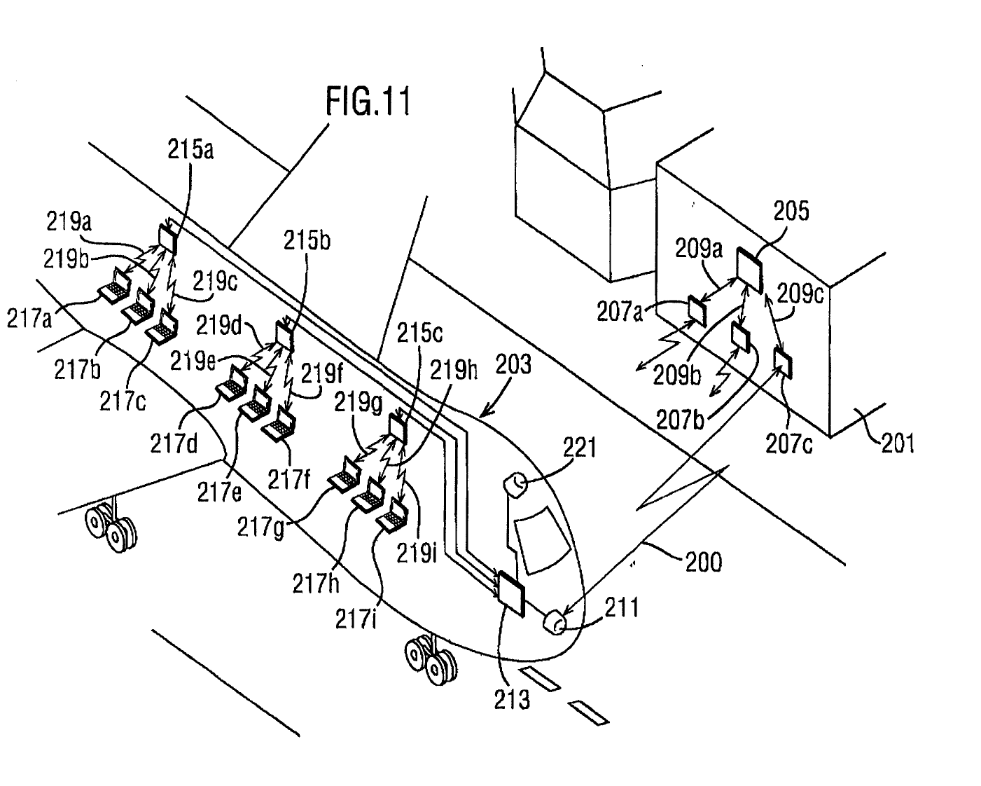

FIG. 11 is a schematic diagram showing a computer network within an aeroplane and also an optical data link between the aeroplane and an airport terminal building;

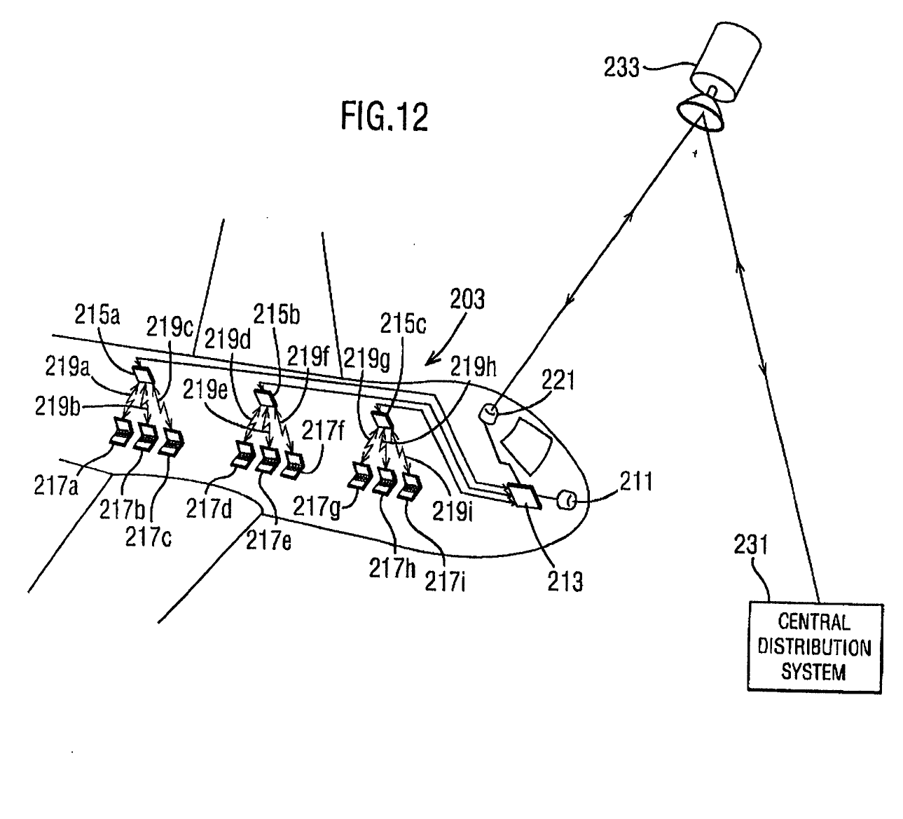

FIG. 12 is a schematic diagram showing the aeroplane of FIG. 11 in flight and a communications link between the aeroplane and a computer network provided on the ground; and

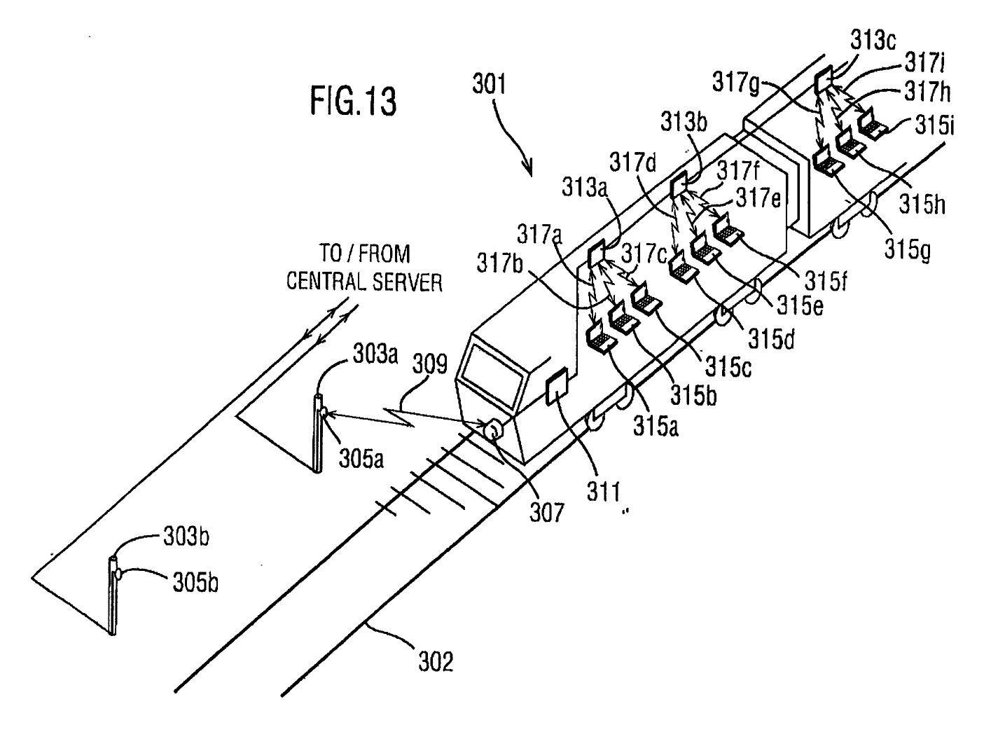

FIG. 13 is schematic diagram illustrating a computer network within a train and an optical data link between the train and fixed nodes provided on posts which are adjacent the railway track.

FIG. 1 schematically illustrates a local area network employed in an office environment which forms a first embodiment of the invention. As shown, the local area network 1 comprises a data bus 3 which connects together network devices such as a personal computer (PC) 5, a printer 7, a modem 9 and a mass storage unit (for example, a file server) 11 located throughout the office. A server 13 which controls the use of the network resources and maintains a record of the status of local area network 1 is also connected to the data bus 3. In this embodiment, the data bus 3 is also connected, via a gateway 15, to a wide area network 17. The purpose and function of each of the network devices described above is well known to those skilled in the art and will not be described further.

The data bus 3 is also connected to a plurality of local data input/output nodes, hereinafter referred to as fixed nodes, two of which are shown in FIG. 1 and referenced 19a and 19b. Each fixed node 19 has an associated “field of view” and is able to establish optical data links with any network devices within this field of view which have a device node (not shown in FIG. 1) which will be described in more detail hereafter. In this embodiment, fixed node 19a is connected with two PCs 23a and 23b, a work station 25 and a printer 27 by optical data links 29a to 29d respectively, and fixed node 19b is connected with a printer 31, laptop computers 33a and 33b, and a PC 35 by optical data links 29e to 29h respectively.

Each optical data link 29 comprises a low divergence, free-space, light beam which is modulated to convey data between the fixed node 19 and the respective network device. In particular, in this embodiment the fixed node 19 emits a light beam which is modulated in accordance with downlink data and directed to a device node, which detects the modulated light beam emitted by the fixed node 19 and recovers the downlink data. The device node also modulates the light beam from the fixed node 19 in accordance with uplink data and retro-reflects the light beam back to the respective fixed node 19, which detects the retro-reflected light beam and recovers the uplink data. In this way, the optical data link 29 is established between the fixed node 19 and the network device.

FIG. 2 schematically illustrates in more detail the main components of a fixed node 19. As shown, the fixed node 19 comprises an interface unit 41 for receiving data from and transmitting data to the data bus 3. Data received from the data bus 3 by the interface unit 41 is input to a processor 43 which generates control signals for a laser driver 45 in accordance with the received data. The laser driver 45 generates drive signals for an emitter array 47 which in this embodiment comprises a two-dimensional pixelated planar array with a vertical cavity surface emitting laser (VCSEL) positioned at each pixel. For ease of illustration, only eight of the VCSELs are shown in FIG. 2.

The use of VCSELs is preferred because the emitter array 47 can then be manufactured from a single semiconductor wafer without having to cut the wafer. This allows a higher density of lasing elements than would be possible for traditional diode lasers.

In this embodiment, the VCSELs emit light beams with a wavelength of 1.55 μm, which is advantageous because the emitted light beams are eye safe and because emitters and detectors at this wavelength are well developed and relatively cheap due to their suitability for the third optical telecommunications window in the transmission spectrum of optical fibres, which extends approximately from 1.45 μm to 1.65 μm.

As shown in FIG. 2, the processor 43 has a separate output for each of the VCSELs of the emitter array 47. The laser driver 45 drives the VCSELs of the emitter array 47 individually in accordance with the control signals output by the processor 43 in order to convey downlink data to the network device. In this way, the fixed node 19 is able to transmit respectively different data to two or more network devices.

The emitter array 47 is positioned in the back focal plane of a telecentric lens 48 which is schematically represented by a lens element 49 and a stop member 51 in FIG. 2, the stop member 51 being located in the front focal plane of the telecentric lens. The purpose of using a telecentric lens is to ensure that the collection efficiency of light from the emitter array 47 is constant across the emitter array 47. Therefore, provided all the emitters are the same, the intensity of the light beam 50 output by the fixed node 19 will be the same for each emitter. Those skilled in the art will appreciate that with a conventional lens the intensity of light beams output from the fixed node would be greater for light beams emitted by emitters in the centre of the array than for those at the edge of the array. Use of the telecentric lens 48 also avoids various cosine falloff factors which are well known in conventional lenses.

The light beam 52 received from the network device is collected by a lens 53, hereafter called the uplink detection lens, which is provided adjacent to the telecentric lens 48. In this embodiment, although the divergence of the light beams of the optical data links 29 is low, the size of the received light beam 52 incident on the fixed node 19 after reflection by a device node is significantly larger than that of the light beam leaving the fixed node. In particular, the beam size of the received light beam is large enough to encompass the telecentric lens 48 and the uplink detection lens 53, although for ease of illustration only the portion of the received light beam 52 incident on the uplink detection lens 53 is shown in FIG. 2.

The uplink detection lens 53 collects the light beam 52 reflected by the network device and directs the light beam to a light detecting element of a detector array 55 which is positioned substantially within the back focal plane of the uplink detection lens 53 so that the uplink detection lens 53 effectively maps directions within its field of view to respective light detecting elements of the detector array 55. As those skilled in the art will appreciate, the uplink detection lens 53 need not be a telecentric lens because it is only required to collect as much light as possible and direct the collected light to the detector array 55. Removing the requirement for telecentricity facilitates increasing the collection aperture of the uplink detection lens 53. In this embodiment, the uplink detection lens 53 has a collection aperture which is twice as large as the collection aperture of the telecentric lens 48.

In this embodiment, the detector array 55 is a two-dimensional array of photodiodes, of which only eight are shown in FIG. 2 for ease of illustration. FIG. 3 is a schematic diagram of the front surface (i.e. the surface facing the uplink detection lens 53) of the detector array 55. As illustrated by the shaded circle 71, in this embodiment the uplink detection lens 53 is designed so that the spot size of a light beam focussed on the surface of the detector array 55 is slightly greater than the size of one of the photodiodes dᵢⱼ, where the spot size is calculated by approximating the intensity of the focussed light beam by a Gaussian profile and calculating the points at which the magnitude of this approximated Gaussian profile has fallen to 1/e² of its maximum value. As those skilled in the art will appreciate, the focussed laser beam will extend beyond the spot 71 so that small signals will be detected by photodiodes neighbouring the photodiode dᵢⱼ of the detector array 55.

Returning to FIG. 2, each photodiode of the detector array 55 converts incident light into a corresponding electrical signal, which is input to a high frequency amplifier 61 which amplifies the detected signals to logic levels and outputs the amplified signals to a switching circuit 59. The amplifier 61 also outputs an indication of the power detected by each of the photodiodes of the detector array 55 to a power monitor 57 which monitors the power levels and determines for which of the photodiodes the detected power level is above a predetermined threshold. The power monitor 57 then outputs a signal to the processor 43 indicating for which of the photodiodes the detected power is above the predetermined threshold level.

The switching circuit 59 is a “n×m” switching circuit having n inputs and m outputs. In FIG. 2, only eight inputs and four outputs are shown for ease of illustration. The processor 43 determines from the signals from the power monitor 57 which of the photodiodes of the detector array 55 are detecting a light beam conveying data, and then sends a control signal to the switching circuit 59 to route the inputs corresponding to those photodiodes to respective output lines. The signals output by the switching circuit 59 are input to respective recovery circuits 63a to 63d which perform a conventional data and clock recovery operation prior to the signals being input to the processor 43, which regenerates the uplink data from the network device and sends the uplink data to the data bus 3 via the interface unit 41.

In this embodiment, in order to determine the location of any network devices within the field of view of the fixed node 19, the processor 43 sends control signals to the laser driver 45 causing the laser driver 45 to drive sequentially all of the VCSELs of the emitter array 47 with an initialisation signal. The light beams 50 conveying the initialisation signal are retro-reflected by any network devices within the field of view and are focussed by the uplink detection lens 53 onto respective photodiodes of the detector array 55. By determining which of the photodiodes 55 receive the initialisation signal, the processor 43 is able to determine the direction of each of the network devices within the field of view. Subsequently, the processor 43 uses only the VCSELs of the emitter array 47 corresponding to those directions to send data, and at regular intervals sequentially sends the initialisation signal using the remaining VCSELs to determine if any new network devices are present. This has the advantage of reducing the power required by the fixed node 19.

If the network device is moved within the field of view, then the focus position of the light beam 52 reflected by the network device will move across the detector array 55. By detecting this movement from the signals generated by the photodiodes, the processor 43 is able to track the movement of the network device and to vary the VCSELs of the emitter array 47 being driven accordingly to ensure that the optical data link is maintained.

FIG. 4 schematically illustrates the main components of one of the device nodes 81 which forms part of a network device. As shown, the device node 81 has an interface unit 83 for receiving data from and transmitting data to the other circuitry of the network device. In particular, the interface unit 83 transmits data received from the network device to a processor 85 which outputs control signals to a modulator driver 87, which in turn outputs drive signals to a modulator array 89, in accordance with the received data. In this embodiment, the modulator elements of the modulator array 89 are individually addressable by the modulator driver 87, with the drive signals output by the modulator driver 87 varying the reflectivity of the modulator elements.

In this embodiment, the modulator array 89 comprises a two-dimensional planar integrated array of Quantum Confined Stark Effect (QCSE) devices (which are sometimes also referred to as Self Electro-optic Effect Devices or SEEDs). FIG. 5A schematically illustrates the cross-section of one of the QCSE devices 111. As shown, the QCSE device 111 comprises a transparent window 113 through which the light beam from the appropriate fixed node 19 passes, followed by three layers 115-1, 115-2, 115-3 of Indium Gallium Arsenide (InGaAs) based material. Layer 115-1 is a p-conductivity type layer, layer 115-2 is an intrinsic layer having a plurality of quantum wells formed therein, and layer 115-3 is an n-conductivity type layer. Together, the three layers 115 form a p-i-n diode. As shown, the p-conductivity type layer 115-1 is connected to an electrode 121 and the n-conductivity type layer 115-3 is connected to a ground node 123. A reflective layer 117, in this embodiment a Bragg reflector, is provided beneath the n-conductivity type layer 115-3, and a substrate layer 119 is provided beneath the reflective layer 117.

In operation, the light beam from the fixed node 19 passes through the window 113 into the InGaAs based layers 115. The amount of light absorbed by the intrinsic layer 115-2 depends upon the DC bias voltage applied to the electrode 121. Ideally, when no DC bias is applied to the electrode 121, as illustrated in FIG. 5A, the light beam passes through the window 113 and is totally absorbed within the intrinsic layer 115-2. Consequently, when there is no DC bias voltage applied to the electrode 121, no light is reflected back to the fixed node 19. On the other hand, when a DC bias voltage of approximately −5 volts is applied to the electrode 121, as illustrated in FIG. 5B, the light beam from the fixed node 19 passes through the window 113 and the InGaAs based layers 115 and is reflected by the reflecting layer 117. Therefore, by changing the bias voltage applied to the electrode 121 in accordance with the drive signals from the modulator driver 87, the QCSE modulator 111 amplitude modulates the received light beam and reflects the modulated light beam back to the fixed node 19.

In the ideal case, as illustrated in FIG. 6, a zero voltage bias, resulting in no reflected light, is applied to the electrode 121 to transmit a binary 0 and a DC bias voltage of −5 volts is applied to the electrode 121, resulting in the light from the fixed node 19 being reflected back from the QCSE device 111, to transmit a binary 1. Typically, however, the QCSE modulator 111 reflects 70% of the light beam when no DC bias is applied to the electrode 121 and 95% of the light beam when −5 volts DC bias is applied to the electrode 121. Therefore, in practice, there is only a difference of about 25% between the amount of light which is detected at the fixed node 19 when a binary 0 is transmitted and when a binary 1 is transmitted.

The amount of the received light beam absorbed by the intrinsic layer 115-2 can be increased by adding additional quantum wells to increase the depth of the intrinsic layer 115-2. However, if the depth of the intrinsic layer 115-2 is increased, then a higher voltage must be applied to the electrode 121 in order to produce the required electric field across the intrinsic layer 115-2 for allowing light to pass through the intrinsic layer 115-2. There is, therefore, a trade-off between the absorptivity of the intrinsic layer 115-2 and the voltage applied to the electrode 121.

By using the QCSE modulators 111, modulation rates of the individual modulator cells in excess of a Gigabit per second can be achieved.

The device node 81 also comprises a detector array 91 having a plurality of light detecting elements, which in this embodiment are photodiodes. Each photodiode converts incident light into a corresponding electrical signal input to a high frequency amplifier 97. In the same manner as for the fixed node 19, the amplifier 97 amplifies the electrical signals to logic levels and outputs the amplified signals to a switching circuit 95. The amplifier 97 also outputs signals indicative of the power detected by each photodiode in the detector array 91 to a power monitor 93, which determines for which of the photodiodes the detected power is above a predetermined threshold level and outputs a signal identifying these photodiodes to the processor 85.

As for the fixed node 19, the switching circuit 95 is a “n—m” switching circuit which for ease of illustration has been shown with eight inputs and four outputs. The processor 85 determines from the signals output by the power monitor 57 which of the photodiodes of the detector array 91 are detecting a light beam conveying data, and then outputs a control signal to the switching circuit 59 which routes the electrical signals from these photodiodes to respective recovery circuits 63a to 63d which perform a conventional clock and data recovery operation. The outputs of the recovery circuits 63 are input to the processor 85 which then recovers the downlink data from the fixed node 19 and outputs the recovered data to the interface unit 41.

As shown in FIG. 4, separate optical systems are provided for the modulator array 89 and the detector array 91. In particular, the modulator array 89 is located substantially within the back focal plane of a telecentric lens 100 which is schematically illustrated in FIG. 4 by a lens element 101 and a stop member 103 which is positioned in the front focal plane of the lens element 101. By using a telecentric lens 100, the principal ray from the fixed node 19 passing through the telecentric lens 100 (i.e. the ray which passes through the centre of the entrance pupil of the telecentric lens 100) is incident perpendicular to the surface of the modulator array 89 and therefore the modulator array 89 reflects the incident light back along its path of incidence. In this way, the reflective modulator array 89 and the telecentric lens 100 form a retro-reflector. Another advantage of using a telecentric lens 100 is that light beams from different directions within the field of view of the telecentric lens are incident on their respective modulator elements at the same angle. In this way, the efficiency of modulation (i.e. the modulation depth), which generally depends upon the angle at which the light beam hits the modulator element, is approximately constant irrespective of the position of the fixed node 19 within the field of view of the telecentric lens 100.

The detector array 91 is positioned in the back focal plane of a respective lens 105, hereinafter called the downlink detection lens, so that the downlink detection lens 105 directs light from directions within its field of view to respective photodiodes of the detector array 91. As those skilled in the art will appreciate, it is not necessary for the principal rays passing through the downlink detection lens 105 to be incident perpendicular to the detector array 91. The downlink detection lens 105 is therefore designed simply to collect as much light from the fixed node 19 as possible and to direct the collected light to a respective photodiode. In this embodiment, the downlink detection lens 105 has a collection aperture which is twice the size of the collection aperture of the telecentric lens 100 for the modulator array 89.

The processor 85 is also connected to an alarm circuit 107 which, as will be described in more detail hereinafter, outputs an alarm signal if the network device is being moved to a position which is outside the field of view of any fixed node 19.

In this embodiment, the optical links 29 between the fixed nodes 19 and the device nodes 81 are full duplex communications links. In particular, in the fixed node 19 the laser driver 45 applies a small signal modulation to the light beam output by the VCSEL array 47. FIG. 7 illustrates this modulation and shows the CW laser level 131 and the small signal modulation 133 applied to it. As those skilled in the art will appreciate, this downlink modulation data becomes an additional noise source for the uplink data. This illustrated in FIG. 8 which shows an eye diagram for the uplink data 135, which includes the interfering downlink data 113, and the consequent reduction in the noise margin 137. However, if the downlink modulation depth is kept sufficiently low, then both the uplink and the downlink can operate with equal bandwidth. In this embodiment, the downlink modulation depth is about 3% of the CW laser level.

In this embodiment, the fixed nodes 19 are mounted to the ceilings of the office rooms and are positioned so that, below a predetermined height above the floor, every position falls within the field of view of at least two fixed nodes, enabling more than one optical data link 29 to be established with each network device located below the predetermined height. An advantage of introducing this redundancy in the number of optical data links 29 will now be explained with reference to FIGS. 9 and 10.

As shown in FIG. 9, two fixed nodes 19_1 and 19_2 are provided on the ceiling of an office and have overlapping fields of view indicated by the cones 141_1 and 141_2, respectively. A network device 143 is positioned in the overlap region so that it is within the field of view of both the fixed node 19_1 and the fixed node 19_2. The field of view of the device node 81 of the network device 143, indicated in FIG. 9 by the cone 145, encompasses both the first and second fixed nodes 19_1, 19_2 and therefore a first optical data link 29_1 can be established between the fixed node 19_1 and the device node 81, and a second optical link 29_2 can be established between the fixed node 19_2 and the device node 81. If one of the optical data links 29 is interrupted, then data communication can still continue using the other optical link 29. For example, as shown in FIG. 9, if a person interrupts the light beam forming the second optical data link 29_2, then data communication can still continue using the first optical data link 29_1.

Further, having redundant optical data links 29 facilitates maintaining a connection as the network device 143 is moved throughout the office because it increases the likelihood that, as the network device 143 moves outside of the field of view of one fixed node 19, an optical data link 29 is already established with another fixed node 19. FIG. 10 illustrates how this can apply even when the network device passes through a door between rooms in the office.

FIG. 10 shows a typical office environment in which two adjacent rooms 151a, 151b are separated by a wall 153 with a doorway 155 provided in the wall 153 to allow movement between the rooms 151. Fixed nodes 19_1 to 19_4 are provided on the ceiling of the room 151a, and fixed nodes 19_5 to 19_8 are provided on the ceiling of the room 151b. As shown in FIG. 10, as the network device 143 passes through the door 155, optical data links 29_3, 29_4 are established with the fixed nodes 19_4 and 19_6 so that the flow of data is not interrupted.

It will be appreciated that there will be positions where an optical link cannot be established, for example a room without any fixed nodes 19. As the general position of the network device within the office can be determined by which of the fixed nodes 19 are being used for the optical data links 29, and the position within the field of view of those fixed nodes 19 can be determined from which of the emitters within the emitter array 47 is being used for the optical data link 29, if the network device is about to move into a region in which an optical data link 29 cannot be established, then the fixed node 19 can send a signal to the network device to activate the alarm circuit 107 which, in this embodiment, provides an audible alarm to the user.

In the first embodiment, the computer network is used in an office environment. The computer network described in the first embodiment can, however, also be used in alternative environments. A second embodiment will now be described with reference to FIGS. 11 and 12 in which a computer network according to the invention is used in an airport and also in an aeroplane. Within the airport, the computer network is a LAN which is substantially as described in the first embodiment, with the fixed nodes being provided on the ceiling of the passenger lounges of the airport terminal. In this way, passengers waiting in the passenger lounges are able to access the computer network, and via the computer network the internet.

In this embodiment, passengers sitting within an aeroplane in the airport are also able to access the computer network provided in the airport terminal. FIG. 11 illustrates an optical data link 200 between the airport terminal building 201 and an aeroplane 203. Further, FIG. 11 also illustrates a separate computer network within the aeroplane 203.

As shown, the terminal building 201 houses a central server 205 which is connected to a plurality of fixed nodes 207a to 207c by respective cables 209a to 209c. In this embodiment, the fixed nodes 207 are substantially identical to the fixed nodes of the first embodiment and will not therefore be described in detail. The fixed nodes 207 are positioned so that their respective fields of view encompass positions in aeroplanes 203 are parked while waiting for take-off. The fixed nodes in the passenger lounges, which are also connected to the central server 205, are not shown in FIG. 11.

The aeroplane 203 has an aeroplane node 211 which, in this embodiment, is substantially identical to the device node of the first embodiment and will not therefore be described in detail. The aeroplane node 211 is connected to an aeroplane server 213 within the aeroplane 203. The aeroplane server 213 is also connected to a plurality of fixed nodes 215 within the cabin of the aeroplane 203 which are substantially identical to the fixed nodes of the first embodiment and will not, therefore, by described in detail. The fixed nodes 215 are used to allow laptop computers 217a to 217i having device nodes substantially as described in the first embodiment to access the aeroplane server 213 via optical data links 219a to 219i respectively.

As shown, the optical data link 200 is established 110 between one of the fixed nodes 207 in the terminal building 201 and the aeroplane node 211 at the aeroplane 203. In this way, while the aeroplane 203 is within range of the fixed nodes 207 provided on the terminal building 201, passengers within the aeroplane 203 can access information from the central server 205 or from the internet.

As shown in FIG. 11, the aeroplane server 213 is also connected to a radio frequency (RF) transceiver unit so that when the aeroplane 203 is out of range of the fixed terminals 207, the passengers within the aeroplane 203 can still access a computer network provided on the ground using an RF link. As shown in FIG. 12, when the aeroplane 203 is in the air, data from a central distribution system 231 is transmitted to the RF transceiver unit 221 using RF signals which are routed via a satellite 233.

Using an optical data link is particularly advantageous in aeroplanes and airports because there are generally very strict regulatory requirements for RF emissions to avoid interference with the electrical equipment in the aeroplanes and airport terminal and RF communication with the aeroplane, whereas no such regulatory requirements exist for optical emissions.

Providing computer network access in a passenger waiting room, such as a passenger lounge in an airport, or a public transport vehicle, such as an aeroplane, is desirable because passengers can then either work or play games using the computer network during periods of time when they have little else to do. The computer network can similarly be installed in other types of public transport building or vehicle.

A third embodiment will now be described with reference to FIG. 13 in which a computer network is installed within a train 301. As shown in FIG. 13, the train 301 runs along a railway track 302 and posts 303a, 303b are provided beside the track 302. A fixed node 305a, 305b is mounted to each of the posts 303 and is connected to a central server (not shown). In this embodiment, the fixed node 305 is substantially identical to the fixed node of the first embodiment and will not therefore be described in detail.

A train node 307, which is substantially identical to the device nodes of the first embodiment and will not therefore be described in detail, is mounted to the train 301. This enables an optical data link 309 to be formed between a fixed node 305 on a post 303 and the train node 307 to enable data communication between the central server and a computer network within the train 301.

As shown, the train node 307 is connected to a train server 311 and the train server 311 is connected to a plurality of fixed nodes 313a to 313c provided throughout the train 301. Each fixed node 313 is able to communication with a plurality of laptop computers 315a to 315i using respective optical data links 317a to 317i. In this embodiment, the fixed nodes 313 and the device nodes of the laptop computers 315 are substantially identical to the fixed nodes and device nodes of the first embodiment respectively and will not therefore be described in detail.

Modifications and Further Embodiments

In the third embodiment, a computer network according to the invention is provided within a train. Those skilled in the art will appreciate that a computer network according to the invention could also be provided in a railway station, for example in the passenger waiting room. Similarly, computer networks according to the invention could be provided in bus stations and busses.

In the first embodiment the computer network is in an office environment. However, the computer network could be used in other business premises, for example a warehouse or a factory.

Those skilled in the art will appreciate that the LAN described in the first embodiment could be configured in many different ways without departing from the invention. For example, the LAN could employ an Ethernet, token ring or a star topology. Further, the computer network need not be a LAN, but could also be, for example, a personal area network.

Preferably, network devices are provided with a plurality of device nodes in order to increase the field of view and therefore increase the likelihood of establishing a data connection with a fixed node without requiring any change in orientation of the network device.

In the described embodiments, VCSELs are used in the emitter array. Other light sources could be used instead, for example edge-emitting laser diodes.

In the described embodiments, the light beams are at a wavelength of 1.55 μm because of the availability of emitters and detectors at this wavelength. Those skilled in the art will appreciate that this applies for wavelengths throughout the third telecommunications window. Further, laser beams are generally eye-safe above approximately 1.2 μm and therefore laser sources above this wavelength could be used. It is even possible to use laser source at wavelengths below 1.2 μm, although the power level will generally have to be kept low to avoid accidental eye damage.

An advantage of using wavelengths which are long enough to be transmitted by GaAs (i.e. above approximately 880 nm) is that a “flip chip” can be used for the modulator array. In a flip chip the drive circuitry of the modulator array is formed on a first substrate and the QCSE devices are grown on a second substrate formed by GaAs. The drive circuitry is then bonded to the QCSE devices with the drive electronics for each QCSE device being directly bonded to that QCSE device. Light beams can then be incident on and pass through the GaAs substrate to the QCSE devices.

Using flip chips is particularly advantageous for addressing rectangular arrays having more than two elements in each direction because otherwise the central elements can be difficult to address. Those skilled in the art will appreciate that materials other than GaAs can be used as the substrate for the QCSE devices, in which case a flip chip can be used provided the wavelength of the laser beams is transmitted by the substrate material.

In the first embodiment, separate emitter and detector arrays having respective different lens systems are used in the fixed node, and separate modulator and detector arrays having respective different lens systems are used in the device node. This has the advantage that each lens system can be individually optimised taking into account its associated optical array. For example, telecentric lenses are provided for the emitter array and the modulator array. Alternatively, a common lens system could be used for the emitter array and detector array in the fixed node, and/or the modulator array and detector array in the device node, with a beam splitter being used to optically co-locate the optical elements. However, using a common lens system can cause unacceptably high levels of back-scattered light onto the detector arrays.

In FIGS. 2 and 4, the circuitry in the fixed node and the device node has been schematically illustrated in terms of functional components in order to illustrate more clearly the working of these devices. Those skilled in the art will appreciate that, in practice, many of the functional components can be combined into single components. For example, the interface unit and the processor can be combined together in a single integrated circuit.

As described in International Patent Application No. PCT/GB01/03113, (the contents of which are incorporated herein by reference) the telecentric lens can be replaced by an objective lens and an array of beam deflecting elements, with each beam deflecting element being associated with a respective element of the optical array and being operable to deflect a principal light ray passing through the objective lens so that it is incident perpendicular to the associated optical element. By incorporating such a telecentric optical component, an optical system which approximates a telecentric lens is provided.

Although the lenses in the fixed node and the device node have been schematically represented by a single lens, it will appreciated that in practice each lens may have a plurality of lens elements.

A number of arrangements are described in International Patent Application WO 01/05069 (the contents of which are incorporated herein by reference) to improve the packing density of the emitter, modulator and detector arrays to achieve better coverage within the field of view.

As described above, the direction of the low-divergence optical beam is varied by selectively addressing different VCSELs in the emitter array. Alternatively, a direction varying mechanism utilising mirrors to steer the optical beam, for example the beam steering system described in International Patent Application WO 01/05072 (the contents of which are incorporated herein by reference), could be used. However, a selectively-addressable array of emitters is preferred to using single emitters with steerable mirrors because separate mirrors are required for each of the emitting elements which is expensive and increases the size, and also steerable mirrors have a slow response time due to the use of electromechanical components.

The illustrated embodiments all utilise a retro-reflector and modem unit which modulates an incoming laser beam from an emitter and detector array using an array of QCSE devices, and reflects the modulated laser beam back to the emitter and detector array. However, as described in International Patent Application WO 98/35328, other retro-reflecting systems could be used in which an incoming optical beam is modulated and then reflected, or alternatively reflected and then modulated. Alternatively, as described in International Patent Application WO 00/48338, the reflector and modem unit could be replaced by a second emitter and detector array.

In the described embodiments, the fixed nodes comprise an array of light emitting elements and the device nodes comprise an array of modulator elements. Alternatively, the device node could comprise the array of light emitting elements and the fixed nodes could comprise the array of modulator elements. However, proving the modulator array in the device node is generally advantageous because the same data will be generally sent to all fixed nodes and therefore a simple driving scheme could be used in which all the modulator elements are driven by the same drive signal. Indeed, a single modulator element could be used, although this is generally not practicable due to the required size.

In the first embodiment, a full duplex transmission systems is described. Alternatively, a simplex transmission system could be used in which an unmodulated light beam is sent to a retro-reflector where it is modulated and reflected back to be detected by a detector. Further, a half-duplex system could be used in which either the fixed node sends an unmodulated light beam to the device node, where it is modulated and reflected back to the user station to convey data in one direction, or modulated data is emitted by the fixed node to convey data to the device node. In this case, as described in International Patent Application WO 01/05071 (the contents of which are herein incorporated by reference), since the QCSE modulator is formed by a p-i-n diode, the QCSE modulator can also be used to detect the amount of incident light.

In the first to third embodiments, QCSE modulators are used. As those skilled in the art will appreciate, other types of reflectors and modulators could be used. For example, a plane mirror may be used as the reflector and a transmissive modulator (such as a liquid crystal cell) could be provided between the lens and the mirror. Further, those skilled in the art will appreciate that the reflectors and/or modulators need not be integrated in a single device and it is also not essential for the reflectors and/or modulators to be located in a common plane, although these features are preferred for ease of device manufacture and alignment.

In the first embodiment, the modulator elements are arranged in a rectangular matrix. However, this is not essential and the modulator elements could be arranged in a different form of regular array or even in an irregular arrangement.

Throughout this specification, data communication between a “fixed node” and a “device node” is described. However, there is no need for one of the data nodes to be fixed. For example, a computer network according to the invention could include just two lap-top computers, each with a data node, which communicate with each other.

1. A computer network comprising first and second signalling devices,
wherein one of the first and second signalling devices comprises: i) a light source operable to emit a light beam; ii) an optical system operable to collect said emitted light beam and to direct the emitted light beam in an exit direction within a field of view of the optical system; iii) a first detector operable to detect the presence of the other of the first and second signalling devices within the field of view; and iv) a beam alignment system operable to vary the exit direction within the field of view of the optical system to enable alignment of said emitted light beam with said other signalling device,
wherein the first signalling device comprises a modulator operable to modulate said light beam, in accordance with data received from a first network device for transmission to a second network device, to form a modulated light beam, and
wherein the second signalling device comprises: a second detector operable to detect the modulated light beam and to convert the modulated light beam into a corresponding electrical signal; and a processor operable to process the corresponding electrical signal to recover said data.

2. A computer network according to claim 1, wherein said light source comprises a plurality of light emitting elements, and said optical system is arranged to direct light from each of the plurality of light emitting elements in a respective exit direction.

3. A computer network according to claim 2, wherein the plurality of light emitting elements comprises at least one electro-optic converter operable to convert a received electrical drive signal into a corresponding optical signal.

4. A computer network according to claim 3, wherein said at least one electro-optic converter comprises a laser.

5. A computer network according to claim 4, wherein the laser is operable to emit a coherent light beam having a wavelength longer than 1.2 μm.

6. A computer network according to claim 5, wherein the laser is operable to emit a coherent light beam having a wavelength between 1.45 μm and 1.65 μm.

7. A computer network according to claim 4, wherein the laser is a vertical cavity surface emitting laser.

8. A computer network according to claim 3, wherein said one signalling device is the first signalling device,
wherein said first signalling device further comprises a drive circuit operable to supply the electrical drive signal to said at least one electro-optic converter, and
wherein the modulator is operable to control the drive circuit in order to modulate the electrical drive signal in accordance with said data, thereby modulating the light beam.

9. A computer network according to claim 2, wherein the plurality of light emitting elements are arranged in a regular array.

10. A computer network according to claim 2, wherein the plurality of light emitting elements are arranged in a two-dimensional array.

11. A computer network according to claim 10, wherein said optical system comprises at least one telecentric optical component.

12. A computer network according to claim 10, wherein said optical system comprises a telecentric lens, and wherein the plurality of light emitting elements are optically located substantially within a focal plane of the telecentric lens.

13. A signalling system according to claim 1, wherein the first detector comprises a plurality of detecting elements, each detecting element being operable to detect light incident from a respective incidence direction within the field of view.

14. A signalling system according to claim 13, wherein the plurality of detecting elements are arranged in a regular array.

15. A computer network according to claim 1, wherein said light source comprises a plurality of light emitting elements, and said optical system is operable to direct light from each of the light emitting elements in a respective exit direction,
wherein the first detector comprises a plurality of detecting elements, each detecting element arranged to detect light from a respective incidence direction within the field of view, and
wherein each light emitting element of said light source is associated with a respective one of the light detecting elements of the first detector, such that the exit direction of a light emitting element is parallel to the incidence direction of its associated light detecting element.

16. A computer network according to claim 15, wherein the plurality of light emitting elements and the plurality of light detecting elements are located separately from each other,
wherein said optical system is an emission optical system, and
wherein a detection optical system is provided to map exit directions within the field of view of the emission optical system to respective light detecting elements.

17. A computer network according to claim 2, wherein said beam alignment system comprises a selector operable to address selectively the plurality of light emitting elements in order to vary the exit direction of the light beam.

18. A computer network according to claim 13, wherein the beam alignment system is operable to vary the exit direction in accordance with which of the detecting elements of the first detector detects the presence of said other signalling device.

19. A computer network according to claim 15, wherein the beam alignment system comprises:
a detection system operable to identify which of the plurality of light detecting elements are detecting a light beam from the other signalling device; and
a selector operable to address selectively the light emitting elements of the associated light emitting element and light detecting element pair corresponding to the light detecting elements identified by the detection system.

20. A computer network according to claim 1, wherein said one signalling device is the first signalling device and said other signalling device is the second signalling device, and wherein said modulator is operable to modulate the light beam emitted by the light source in accordance with said data.

21. A computer network according to claim 20, wherein:
said second signalling device further comprises a light reflector for reflecting the light beam received from the first signalling device back to the first signalling device in order to indicate the presence of the second signalling device;
said first detector of the first signalling device is operable to determine the direction of incidence of the reflected light beam; and
said beam alignment system is operable to vary the exit direction in accordance with the direction of incidence of the reflected light beam.

22. A computer network according to claim 21, wherein said light reflector comprises a retro-reflector.

23. A computer network according to claim 20, wherein the modulator of the first signalling device is a first modulator, and the second signalling device comprises a second modulator for modulating the light beam emitted from the light source of the first signalling device in accordance with additional data.

24. A computer network according to claim 23, wherein said second signalling device further comprises a light reflector for reflecting the light beam received from the first signalling device back to the first signalling device in order to indicate the presence of the second signalling device;
wherein said first detector of the first signalling device is operable to determine the direction of incidence of the reflected light beam; and
wherein said beam alignment system is operable to vary the exit direction in accordance with the direction of incidence of the reflected light beam.

25. A computer network according to claim 24, wherein said second modulator and said light reflector are formed as a single unit.

26. A computer network according to claim 25, wherein the single unit comprises at least one quantum confined Stark effect device.

27. A computer network according to claim 26, wherein the second modulator is operable to modulate a voltage applied to the or each quantum confined Stark effect device, thereby modulating the reflectivity of the quantum confined Stark effect device, in accordance with said additional data.

28. A computer network according to claim 25, wherein the single unit comprises an array of modulating and reflecting elements.

29. A computer network according to claim 25, wherein said optical system of the first signalling device is a first optical system, and the second signalling device further comprises a second optical system for collecting the light beam emitted from said light source of the first signalling device and for directing the collected light beam to the light reflector.

30. A computer network according to claim 29, wherein said second optical system comprises at least one telecentric optical component.

31. A computer network according to claim 29, wherein said second optical system comprises a telecentric lens and said light reflector is optically located substantially at a focal plane of the second optical system.

32. A computer network according to claim 20, wherein:
said light source is a first light source for emitting a first light beam, said modulator is a first modulator, said optical system is a first optical system; and
said second signalling device further comprises: a second light source for emitting a second light beam; a second optical system for collecting the second light beam and directing the second light beam in a corresponding exit direction; and a second modulator for modulating the second light beam in accordance with additional data to be transmitted to the first signalling device.

33. A computer network according to claim 1, wherein the computer network is local area network.

34. A network device operable to transmit data to another network device using a computer network, the network device comprising:
an optical system operable to collect a light beam from a remote light source and to direct the collected light beam onto a reflector, wherein the reflector is operable to reflect the collected light beam back towards said remote light source; and
a modulator operable to modulate the collected light beam in accordance with said data.

35. A network device operable to transmit data to another network device using a computer network, the network device comprising:
a light source operable to emit a light beam;
an optical system operable to collect said emitted light beam and to direct the emitted light beam in an exit direction within a field of view of the optical system;
a detector operable to detect the presence of the a signalling device within the field of view;
a beam alignment system operable to vary the exit direction within the field of view of the optical system to enable alignment of said emitted light beam with said signalling device; and
a modulator operable to modulate the light beam in accordance with said data.

36. A business premises housing a computer network comprising first and second signalling devices,
wherein one of the first and second signalling devices comprises: i) a light source operable to emit a light beam; ii) an optical system operable to collect said emitted light beam and to direct the emitted light beam in an exit direction within a field of view of the optical system; iii) a first detector operable to detect the presence of the other of the first and second signalling devices within the field of view; and iv) a beam alignment system operable to vary the exit direction within the field of view of the optical system to enable alignment of said emitted light beam with said other signalling device, and
wherein the first signalling device comprises a modulator operable to modulate the light beam in accordance with data received from a first network device for transmission to a second network device, and
wherein the second signalling device comprises: a second detector operable to detect the modulated light beam and to convert the modulated light beam into a corresponding electrical signal; and a processor operable to process the corresponding electrical signal to recover said data.

37. A public transport station having a computer network including at least one signalling device comprising:
an optical system operable to collect a light beam from a remote light source and to direct the collected light beam onto a reflector, wherein the reflector is operable to reflect the collected light beam back towards said remote light source; and
a modulator operable to modulate the collected light beam in accordance with said data.

38. A public transport station according to claim 37, wherein the public transport building is an airport.

39. A public transport station according to claim 37, wherein the public transport building is a railway station.

40. A public transport station having a computer network including at least one signalling device comprising:
a light source operable to emit a light beam;
an optical system operable to collect said emitted light beam and to direct the emitted light beam in an exit direction within a field of view of the optical system;
a detector operable to detect the presence of another signalling device within the field of view;
a beam alignment system operable to vary the exit direction within the field of view of the optical system to enable alignment of said emitted light beam with said another signalling device; and
a modulator operable to modulate the light beam in accordance with said data.

41. A public transport station according to claim 40, wherein the public transport building is an airport.

42. A public transport station according to claim 40, wherein the public transport building is a railway station.

43. A public transport vehicle having a computer network comprising including at least one signalling device comprising:
an optical system operable to collect a light beam from a remote light source and to direct the collected light beam onto a reflector, wherein the reflector is operable to reflect the collected light beam back towards said remote light source; and
a modulator operable to modulate the collected light beam in accordance with said data.

44. A public transport vehicle according to claim 43, wherein the public transport vehicle is an aeroplane.

45. A public transport vehicle according to claim 43, wherein the public transport vehicle is a train.

46. A public transport vehicle having a computer network including at least one signalling device comprising:
a light source operable to emit a light beam;
an optical system operable to collect said emitted light beam and to direct the emitted light beam in an exit direction within a field of view of the optical system;
a detector operable to detect the presence of the another signalling device within the field of view;
a beam alignment system operable to vary the exit direction within the field of view of the optical system to enable alignment of said emitted light beam with said another signalling device; and
a modulator operable to modulate the light beam in accordance with said data.

47. A public transport vehicle according to claim 46, wherein the public transport vehicle is an aeroplane.

48. A public transport vehicle according to claim 46, wherein the public transport vehicle is a train.
